(19) United States
(12) Patent Application Publication
(10) Pub. No.: US 2005/0278623 A1
(43) Pub. Date: Dec. 15, 2005

(54) Code, system, and method for generating documents

(76) Inventors: Peter J. Dehlinger, Palo Alto, CA (US); Shao Chin, Felton, CA (US)

Correspondence Address: PERKINS COIE LLP, P.O. BOX 2168, MENLO PARK, CA, 94026, US

(21) Appl. No.: 11/129,147

(22) Filed: May 13, 2005

Related U.S. Application Data
(60) Provisional application No. 60/572,177, filed on May 17, 2004.

(51) Int. Cl. G06F 17/00

(52) U.S. Cl. 715/517

(57) ABSTRACT

Disclosed are a computer-readable code, system and method for assisting in the preparation of a target document. The system stores a plurality of template documents which are each parsed into passages, typically paragraphs. The individual passages from the several template documents form a database of model passages from which a new document can be constructed. To retrieve a particular passage, the user describes the content of interest, or represents the content as a string of words and/or word groups. The system uses a word-records file to identify one or more descriptive passages having the highest match score with the user description. From these highest-matching passages, the user selects one or more descriptive passages for use in document construction.

This application claims priority of U.S. Application No. 60/572,177 filed May 17, 2004, which is incorporated in its entirety herein by reference.

### FIELD OF THE INVENTION

The present invention relates to a computer system, machine-readable code, and a computer-assisted method for generating documents.

### BACKGROUND OF THE INVENTION

Much of the professional time of lawyers, scientists, scholars, academic researchers and professional business writers is devoted to generating written documents, for example, scientific papers, patent applications, legal opinion, agreements, business documents, scholarly works, reports, and manuals. Typically, in the construction of a new written document, the writer will draw on material from previously prepared documents for ideas and modes of expression related to the subject matter at hand. In preparing a legal agreement, for example, a lawyer may draw on previously prepared agreements for boiler-plate language, and those terms of the agreement that apply to the new agreement. In preparing a scientific paper, a scientist may rely on earlier papers to describe methods and protocols, background material, and even a discussion of the data. In short, the writer will synthesize new ideas, data, or other descriptive material with previously prepared passage to construct the new document.

In practice, the writer may attempt to find a paragraph or passage of interest from an earlier document by searching through his or her electronic files or by searching published documents available through a search service or through the internet. The amount of effort required to locate the earlier document, then check the document to determine whether the passage of interest is present may take more time than composing a new paragraph or passage from scratch.

It would therefore be useful to provide a document generating system that allows a writer to efficiently locate and incorporate passages or paragraphs from a number of template documents related to a given topic, for purposes of constructing a new document on that topic.

### SUMMARY OF THE INVENTION

In one aspect, the invention includes a computer-assisted method for constructing a target document composed of a series of descriptive passages that describe a topic. In practicing the method, each of a plurality of descriptive passages that are to be included in the target document is represented in the form of a summary description of the content of that passage. For each summary description so represented, a database of word records is accessed, to identify those non-generic words contained in the summary description that are contained in a set of descriptive passages. The word-records database is composed of (i) non-generic words contained in the set of descriptive passages taken from a plurality of template documents that represent topics similar to those of the target document, and (ii) for each word in the database, passage identifiers associated with that word in the set of descriptive passages.

For each of the words in the summary description so identified, the method uses passage identifiers in the word-records database to identify those descriptive passages having the highest word overlap with the summary description, then accesses a database of the descriptive passages identified by passage identifiers to retrieve those identified passages. One or more of the retrieved descriptive passages are displayed to the user. If the displayed descriptive passages contain a passage suitable for insertion into the target document, the user may select that passage to replace the summary description of the content of that passage in the target document. These steps are repeated, and for each of the summary descriptions.

In identifying descriptive passages having highest word overlap with the summary description, the method may include (i) constructing a search vector composed of non-generic word terms present in the description, (ii) displaying to the user, the terms in the search vector that are present in the identified descriptive passages, and (iii) allowing the user to adjust the search vector to emphasize or de-emphasize selected terms. The search steps may be repeated until a suitable descriptive passage is found or the user concludes that no suitable descriptive passage is present in the database of descriptive passages.

Each non-generic word in the summary description may be assigned the same coefficient in the search vector. Alternatively, each non-generic word in the summary description may be assigned a coefficient related to the ratio of (i) number occurrence of a term in a library of texts related to one field, to (ii) the number occurrence of the same terms in a library of texts related to one or more other fields.

Where the summary description of the content of a passage is represented as a description in natural-language passage, the method may include classifying words in the summary description as either (i) generic, (ii) verb-root, or (iii) remaining words that are neither (i) nor (ii), discarding generic words, and converting verb-root words to a common verb root. In this embodiment, verb-root words in the word-records database may be expressed in verb-root form.

The words in the word-records database may further include word-position identifiers that identify the word position(s) of that word in each descriptive passage containing that word. Here constructing the search vector may include identifying word-pair terms from proximately arranged words in the summary description, and using passage and word-position identifiers in the word-records database associated with the identified word-pair terms to identify those descriptive passages having the highest word and word-pair overlap with the summary description.

The words in the word-records database may further include category identifiers that identify a category of a template document from which the associated descriptive passage is found. In this embodiment, the user may specify a category identifier for each summary description of the content of a given passage, and the search step may include using passage and category identifiers in the word-records database, to identify those descriptive passages having the specified category and the highest word overlap with the summary description.

For use in preparing a patent specification, the template documents are patents or patent applications and the categories include two or more of background, definitions, description, examples, and/or claims. For use in preparing a legal agreement, the template documents are already-prepared agreements, and the categories include two of more of recitals, definitions, grant, rights, obligations, term, termination, and/or miscellaneous. For use in preparing a scientific report, the template documents are existing scientific reports or papers, and the categories include two or more of introduction, methods, results, and discussion.

In an exemplary embodiment, the descriptive passages in the template documents are document paragraphs having a word length greater than a selected length, e.g., 15-30 words. In this embodiment, the database of descriptive passages may include all of the paragraphs of the template documents, and the system may be designed to display to the user, on command, document paragraphs that precede and follow a selected displayed paragraph.

In another aspect, the invention includes an automated system for constructing a target document that represents a selected target topic and is composed of a series of descriptive passages related to that topic. The system includes (1) a computer, (2) a database of descriptive passages and a word-records database (preferably the same database) accessible by the computer, and (3) a computer readable code that is operable, under the control of the computer, to perform the method steps described above. The database of descriptive passages is constructed from a plurality of template documents which represent topics similar to those of the target document, and the word-records database is composed of (i) non-generic words contained in the descriptive passages, and (ii) for each word in the file, passage identifiers associated with that word in the set of descriptive passages. The words in the word-records database may further include category identifiers that identify a category within a template or assigned to one or more template documents from which the associated descriptive passage is found.

Also disclosed is computer-readable code for use with an electronic computer, for carrying out the above method by accessing a database of descriptive passages and a word-records file of the type described.

In still another aspect, the invention includes a computer-assisted method for accessing passages contained in one of plurality of categories in a plurality of documents. In this method, each of a plurality of passages to be accessed is represented in the form of a summary description of the content of that passage, and with a specified category. For each summary description so represented, the method accesses a database of word records of the type described above, to identify those words contained in the summary description that are contained in the file. The method then uses passage and category identifiers in the file associated with the summary-description words to identify those descriptive passages having the highest word overlap with the summary description. A database of the passages identified by passage and category identifiers is then accessed to retrieve those passages identified in above, and these passages are displayed to the user. The process is repeated for each of the summary descriptions.

These and other objects and features of the invention will become more fully apparent when the following detailed description of the invention is read in conjunction with the accompanying drawings.

### BRIEF DESCRIPTION OF THE DRAWINGS

FIG. 1 illustrates components of the system of the invention;

FIG. 2 shows, in flow diagram form, search operations for identifying template document, for use in the system of the invention;

FIG. 3 shows, in flow diagram form, operations of the system for processing template documents for use in the system of the invention;

FIG. 4 is a flow diagram of steps for processing a natural-language passage;

FIG. 5 is a flow diagram of steps for generating a template word-records database;

FIG. 6 is a flow diagram of operations carried out in generating a document, in accordance with the invention;

FIG. 7 shows a graphical interface in the system for identifying template documents; and

FIG. 8 shows a graphical interface in the system for constructing a documents, in accordance with the invention.

### DETAILED DESCRIPTION OF THE INVENTION

A. Definitions

“Natural-language text” refers to passage expressed in a syntactic form that is subject to natural-language rules, e.g., normal English-language rules of sentence construction.

A “paragraph” refers to its usual meaning of a distinct portion of written or printed material dealing with a particular idea or thought, usually beginning with an indentation, and including one or more separate sentences.

A “descriptive passage” refers to a passage in a text that is descriptive of a particular idea, notion, of thought. A descriptive passage will typically be a paragraph within a document, but may also encompass a portion of a paragraph or multiple paragraphs.

A “document” refers to a self-contained written or printed work, such as an article, patent, agreement, legal brief, book, treatise or explanatory material, such as a brochure or guide, being composed of plural paragraphs or passages.

A “section” or “category” of a document refers to a portion of a document dealing with one of the two or more subdivision of the document. As examples, a patent will include separate categories for background, examples, claims and detailed description. A scientific paper will contain separate categories for background, methods, results and discussion. A legal agreement will contain separate categories for definitions, grant, monetary obligations, termination, and so forth. A scholarly treatise may contain separate categories for introduction, methodology, results, and conclusions. Each category is typically composed of multiple paragraphs, although shorter sections, such as background or introduction may be composed of a single paragraph. In some cases, a category may refer to one or more documents have been assigned to a common class or name.

A “target document” refers to a document which is to be generated by the system of the invention, and dealing with a specific topic or subject.

A “summary description of the content” of a descriptive paragraph refers to a natural language text, e.g., a single descriptive sentence, or as a list of word and/or word-group terms that are descriptive of the content of the descriptive paragraph to be found.

A “template document” refers to a document dealing with the same topic or subject as the target document, and typically has the same document format, e.g., patent application, agreement, scientific paper, or treatise as the template documents.

“Processed text “refers to computer readable, passage-related data resulting from the processing of a digitally-encoded texts to generate one or more of (i) non-generic words, (ii) wordpairs formed of proximately arranged non-generic words, (iii) word-position identifiers, that is, sentence and word-number identifiers.

A “verb-root” word is a word or phrase that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language text that are not descriptive of, or only non-specifically descriptive of, the subject matter of the text. Examples include prepositions, conjunctions, pronouns, as well as certain nouns, verbs, adverbs, and adjectives that occur frequently in texts from many different fields. “Non-generic words” are those words in a text remaining after generic words are removed.

A “word group” is a group, typically a word pair, of non-generic words that are proximately arranged in a natural-language text. Typically, words in a word group are non-generic words in the same sentence. More typically they are nearest or next-nearest non-generic word neighbors in a string of non-generic words, e.g., a word string.

Words and optionally, words groups, usually encompassing non-generic words and wordpairs generated from proximately arranged non-generic words, are also referred to herein as “terms”.

“Field” refers to a given technical, scientific, legal or business field, as defined, for example, by a specified technical field, or a patent classification, including a group of patent classes (superclass), classes, or sub-classes. A field may have its own taxonomic definition, such as a patent class and/or subclass, or a group of selected patent classes, i.e., a superclass. Alternatively, the field may be defined by a single term, or a group of related terms. Although the terms “class” and “field” may be used interchangeably, in general, the term “class” will generally will refer to a relatively narrow class of texts, e.g., all texts in a contained in a patent class or subclass, or related to a particular concepts, and the term “field,” to a group of classes, e.g., all classes in the general field of biology, or chemistry, or electronics.

“Library of texts in a field” refers to a library of texts (digitally encoded or processed) that have been preselected or flagged or otherwise identified to indicate that the texts in that library relate to a specific class or field. For example, a library may include patent abstracts from each of up to several related patent classes, from one patent class only, or from individual subclasses only.

“Frequency of occurrence of a term (word or word group) in a library” is related to the numerical frequency of the term in the library of texts, usually determined from the number of texts in the library containing that term, per total number of texts in the library or per given number of passages in a library. Other measures of frequency of occurrence, such as total number of occurrences of a term in the texts in a library per total number of passages in the library, are also contemplated.

A “function of a selectivity value” a mathematical function of a calculated numerical-occurrence value, such as the selectivity value itself, a root (logarithmic) function, a binary function, such as “+” for all terms having a selectivity value above a given threshold, and “−” for those terms whose selectivity value is at or below this threshold value, or a step function, such as 0, +1, +2, +3, and +4 to indicate a range of selectivity values, such as 0 to 1, >1-3, >3-7, >7-15, and >15, respectively. One preferred selectivity value function is a root (logarithm or fractional exponential) function of the calculated numerical occurrence value. For example, if the highest calculated-occurrence value of a term is X, the selectivity value function assigned to that term, for purposes of passage matching, might be X^{1/2} or X^{1/2.5}, or X^{1/3}.

A “library identifier” or “LID” identifies the field, e.g., technical field patent classification, legal field, scientific field, security group, or field of business, etc. of a given passage.

A “document identifier” or “DID” identifies a particular digitally encoded or processed document in a database, such as patent number, bibliographic citation or other citation information. A template document identifier is indicated by TDID.

A “category identifier” or “CID” (also “section identifier”) or identifies a particular category within or among documents.

A “passage identifier” or “text identifier” or “TID” uniquely identifies a particular passage, typically a particular paragraph, within a group of template documents. The passage identifier may include separate document and paragraph identifiers for each passage, e.g., paragraph. in each document, or may include a single unique passage number for all passages in all documents.

A “word-position identifier” of “WPID” identifies the position of a word in a text. The identifier may include a “sentence identifier” which identifies the sentence number within a text containing a given word or word group, and a “word identifier” which identifiers the word number, preferably determined from distilled text, within a given sentence. For example, a WPID of 2-6 indicates word position 6 in sentence 2. Alternatively, the words in a passage, preferably in a distilled text, may be number consecutively without regard to punctuation.

A “database” refers to a database of records containing information about documents, e.g., the document itself in actual or processed form, document identifiers, category identifiers, word-position identifiers, and selectivity values. The information in the database may be linked by certain file information, e.g., document numbers or words, e.g., in a relational database format.

A “documents database” refers to database of processed and/or unprocessed texts, e.g., paragraphs, in which the key locator in the database is a passage identifier (TID). The information in the database is stored in the form of passage records, where each record can contain, or be linked to files containing, (i) the actual natural-language text, and/or the text in processed form, typically, in the form of a list of all non-generic words and word groups in the text, (ii) passage identifiers, and/or (v), word-position identifiers for each word.

A “word database” or “word-records database” refers to a database of words in which the key locator in the database is a word, typically a non-generic word. The information in the database is stored in the form of word records, where each record can contain, or be linked to files containing, (i) selectivity values for that word, (ii) identifiers of all of the passages containing that word, and (iii) for each document passage, word-position identifiers identifying the position(s) of that word in that passage, e.g., paragraph. The word-records database preferably includes a separate record for each word. The database may include links between each word file and linked various identifier files, e.g., passage files containing that word, or additional passage information, including the passage itself, linked to its passage identifier. The word-records and document databases are typically combined into a single database.

A “template documents database” of template documents file” refers to a file containing template document passages, e.g., paragraphs in unprocessed and/or processed form, typically both. Each different topic or subject may have a separate document database of file, i.e., composed of paragraphs from a group of related template documents only, or may be a composite file, composed of paragraphs from template documents relating to two or more different subjects or topics. In the latter case, each paragraph may additional include a topic identifier that identifies the particular topic or group of template documents to which that paragraph belongs.

A “template word-records database” refers to a word-records database of template document, either for a given subject or topic or for several different topics or subjects.

A “topic” or “subject” has its usual meaning of the subject or theme of a written work or document.

B. System Components

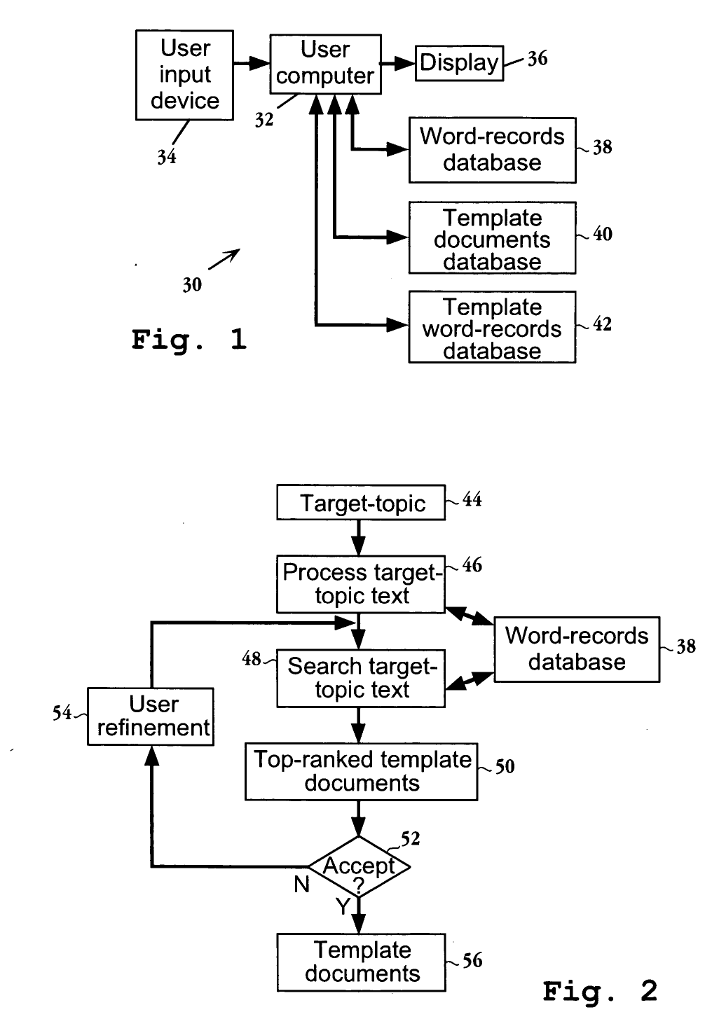

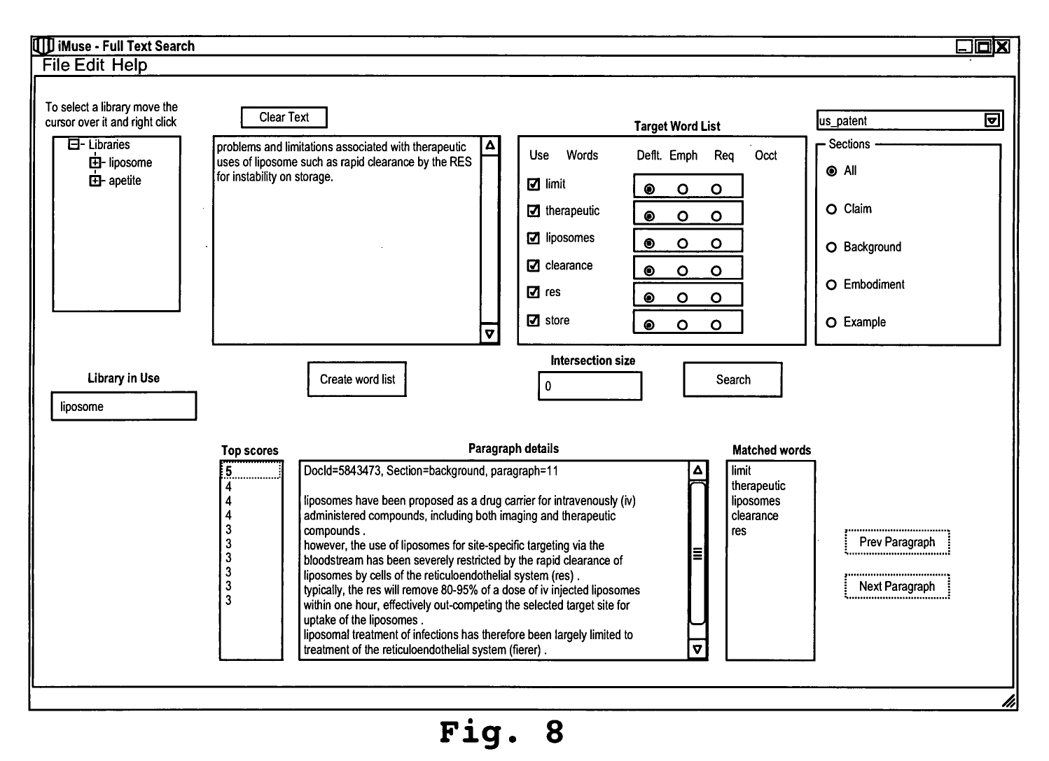

FIG. 1 shows the basic components of a system 30 for assisting a user in generating a new document in accordance with the present invention. A computer or processor 32 in the system may be a stand-alone computer or a central computer or server which communicates with a user's personal computer. The computer has a input device 34, such as a keyboard, modem, and/or disc reader, by which the user can enter target-passage information and refine search results, as will be seen below. A display or monitor 36 displays the search and document generation interfaces described below with respect to FIGS. 8 and 9, and allows user input and feedback, and system output. The system further includes a word-records database 38 that may be used for certain search operations.

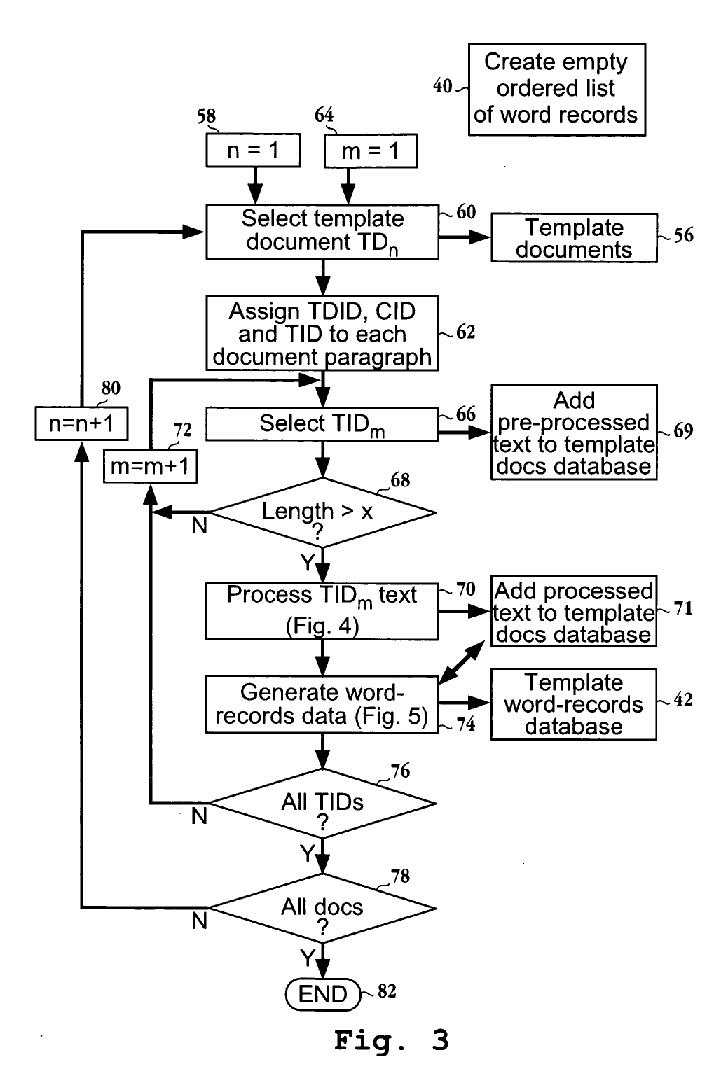

Also included in the system is a template documents database 40 which includes template document passages, e.g., paragraphs, in preprocessed and processed form. The descriptive passages in the database will be located and displayed to the user, for incorporation into a target document being constructed. The selection of template documents is described in Section C below with respect to FIG. 2. Section C also describes steps in the processing of template documents to form a template-documents database or file, with reference to FIG. 3.

A template word-records database 42 in the system provides a dictionary of template-documents non-generic words and associated identifiers. In one embodiment, each word in the database includes (i) the passage identifier (TID) of each passage, e.g., paragraph, containing that word (where the passage identifier may include both a document identifier and a passage, e.g., paragraph identifier within that document), category identifier CID for each TID, and one or more word position identifiers WPID for each TID.

C. Identifying and Processing Template Documents

The template documents provide the passages, e.g., paragraphs, that the user will access in the course of constructing a new document. The template document, therefore, are preferably closely related in subject matter and style to the target documents one wishes to generate. For example, in constructing a new patent application, the template documents are preferably patents and/or patent applications that describe and claim inventions that are similar in components, objectives, and operations to the invention of the target application.

Depending on the type of document being prepared, one or more separate sets or libraries of template documents may be required. A single set of template opinion documents or legal agreements may serve, for example, in constructing opinions or agreements. Here, a set of selected template documents are loaded into the system, for use in constructing a number of different target document, without having to construct a new template-document library for each new target document. For other types of documents, such as patent documents or scientific reports, a different set of template documents may be required for each different type of invention or discovery. In this case, the user may have to identify and assemble a new set of template documents for each new target document. In either case, the number of template documents in a set of library is typically between 3-50 or more, and in any case, a large enough set to provide template paragraphs for a significant percentage of target paragraphs to be generated.

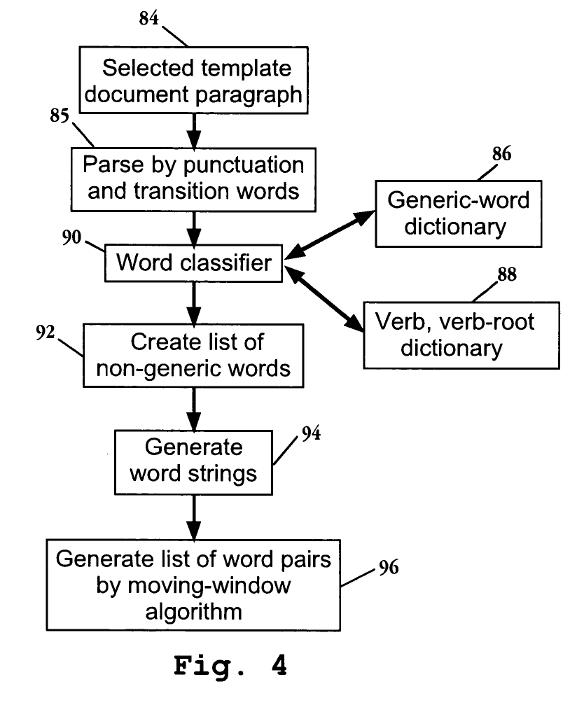

FIG. 2 illustrates one method for identifying suitable template documents, particularly when generating a target document that is topic specific, e.g., a patent application or scientific report. Briefly the user enters a description of the target topic in natural language text, e.g., a summary of an invention or discovery, at 44. The target-topic text is processed at 46, and as described with respect to FIG. 4, to identify non-generic words and word pairs in the text. Each of these word and word-pair terms is assigned a selectivity value for that term, as an indication of the descriptiveness of the term. The selectivity values are preferably determined by word data available in word-records database 38. To that end, the word-records database is constructed to include word records for a typically large number of texts from which the template documents will be selected. For example, if the template documents are to be selected from patents or patent application, the word records database is preferably constructed from a large library of patents texts, e.g., abstract, from which the template documents can be chosen.

From the selectivity determined values, and optionally, from an inverse document frequency (IDF) determined for each word term, the system constructs a search vector used in searching word and word-pair terms accessible from word-records database 38. The search operation, indicated at 48, yields a small number e.g., 10-30 top-ranked template documents 50 from which the user can select those template documents that seem closest in subject matter, methodology and/or objects to the target document to be constructed, and preferably cover a range of potentially different subjects likely to be included in the target document. The foregoing text processing and search method are described in greater detail in co-owned PCT patent application for “Text-Representation, Text Matching, and Text Classification Code, System, and Method,” having International PCT Publication Number WO 2004/006124 A2, published Jan. 14, 2004, which is incorporated herein by reference in its entirety and referred to below as “co-owned PCT application.”

The user may be satisfied with the selection of template documents, as at 52, in which case the method yields a final set of template documents at 56. Alternatively, the user may wish to refine the search, at 54, to expand or sharpen the template document selection, before making a final selection of template documents. Note that the selection of template documents may be made on the basis of a summary description of the document, e.g., an abstract of an invention or discovery, rather than from the full text of each template document.

Once a set of template documents are chosen, each template document itself is then processed as illustrated in the flow diagram in FIG. 3, to yield a template-documents database 40 and a template word-records database 42, both of which will be employed by the present system in document generation, as indicated in FIG. 1 and as discussed further below with respect to FIG. 6.

In the operation of the program, an empty file of template documents 40 is created, the template-document identifier number (TDID) n is initialized to 1 at 58, and paragraph identification number (PID) m is initialized to 1 at 64. The program selects a template document TDIDₙ at 60 from the set of selected template documents 56. The program assigns to each successive paragraph (passage) in the selected document, a template-document ID (TDID), a category ID (CID), and a text or passage ID (TID). The TDID is typically a patent or bibliographic identifier, such as a patent number or bibliographic citation. The CID identifies the particular section of the document which contains the paragraph being processed, or may identify one type or name of document among the template documents. For example, if the document being processed is a patent, section headings such as Background, Summary, Figure Description, Detailed Description, Examples, and claims, or variants of these headings are read, and each paragraph within that section is assigned this section ID. Exemplary section headings might include, for each of the following types of documents:
Patents and patent applications: Background, Summary, Figure Description, Detailed Description, Examples, and claims;
Agreements: Whereas Clauses, Definitions, Grant, Royalty Obligations, Patents, Termination, Miscellaneous;
Scientific Reports: Background, Methods, Results, Discussion
Business Plans and Reports: Executive Summary, Product and Service, Market, Financial Projections, Competitive Advantage.

The passage identification TID is a successive integer assigned to each successive passage, e.g., paragraph in a document, where the passage paragraph numbering in each successive document starts from the last numbered paragraph in the previous paragraph, so that each paragraph in the database is assigned a different number. The TID, in effect, serves as a unique passage identifier for that passage, e.g., paragraph, in the database of template documents.

Once the passages, e.g., paragraphs, in document n have been assigned TDID, CID and TID values, each passage in the document is processed successively, beginning with passage 1 in the first document. The actual passage (preprocessed or unprocessed passage) is added to list 40 along with its passage identifiers, as seen at 66. The next step is to determine whether the passage is of sufficient length, typically greater than 20 words or so, to be processed, as indicated at 68. This will eliminate for processing, short, essentially non-descriptive paragraphs, such as table or figure headings, or mathematical formulae. If the passage is no more than a preselected length x, the program increments m, at 72, and selects the next passage for processing.

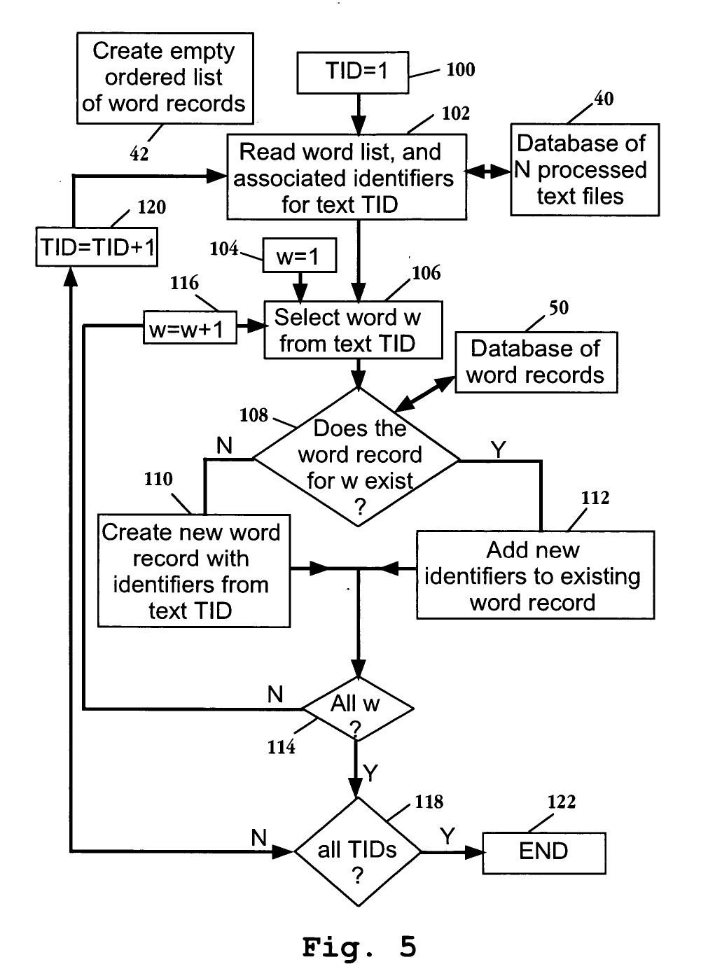

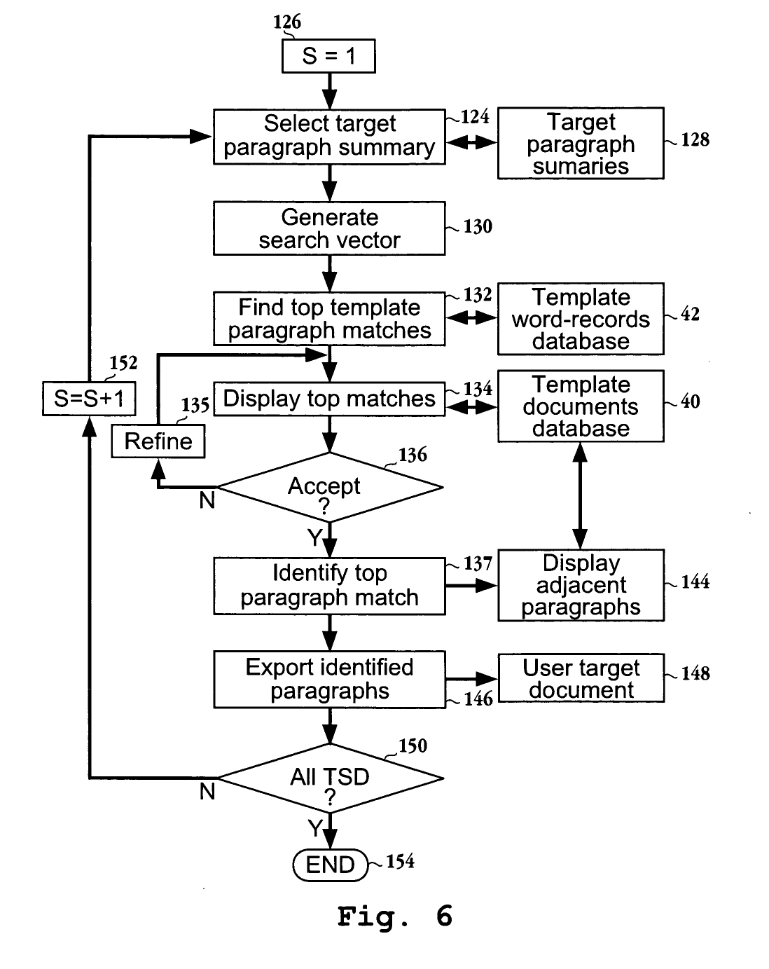

If the passage has a length greater than x, it is processed to form a processed passage. As will be described below with respect to FIG. 4, the processed passage includes lists of non-generic words, each identified with a word-position identifier (WPID), and may also include a list of word pairs formed of proximate non-generic words. The processed passage is placed in the list or database 40, typically in association with the pre-processed passage, as indicated at 71. Once the passage is processed, the program uses the words and their identifiers in the template-documents database to construct word-records database 42, as indicated at 74, and as described below with reference to FIG. 5.

When these text processing operations are complete, the program advances to the next passage m in document n, through the logic of 76 and 72, and repeats the text processing steps until all passage in the document have been added to the template-documents database and all words in the processed passage have been added to the template word-records database. This procedure, in turn, is repeated, though the logic of 78 and 80 until all template n documents are processed, ending the 82.

FIG. 4 illustrates the steps in the processing of a selected paragraph of a template document, as representative of processing a passage. The selected paragraph at 84 represents the mth paragraph of the nth template document in the processing steps illustrated in the previous figure. The first step in the paragraph processing module of the program is to “read” the paragraph for punctuation and other syntactic clues that can be used to parse the paragraph into smaller units, e.g., single sentences, phrases, and more generally, word strings. These steps are represented by parsing function 85 in the module. The design of and steps for the parsing function are described more fully in the above-cited co-owned PCT patent application.

After the initial parsing, the program carries out word classification functions, indicated at 90, which operates to classify the words in the paragraph into one of three groups: (i) generic words, (ii) verb and verb-root words, and (iii) remaining groups, i.e., words other than those in groups (i) or (ii), the latter group being heavily represented by non-generic nouns and adjectives.

Generic words are identified from a dictionary 86 of generic words, which include articles, prepositions, conjunctions, and pronouns as well as many noun or verb words that are so generic as to have little or no meaning in terms of describing a particular invention, idea, or event. For example, in the patent or engineering field, the words “device,” “method,” “apparatus,” “member,” “system,” “means,” “identify,” “correspond,” or “produce” would be considered generic, since the words could apply to inventions or ideas in virtually any field. In operation, the program tests each word in the passage against those in dictionary 86, removing those generic words found in the database.

A verb-root word is similarly identified from a dictionary 88 of verbs and verb-root words. This dictionary contains, for each different verb, the various forms in which that verb may appear, e.g., present tense singular and plural, past tense singular and plural, past participle, infinitive, gerund, adverb, and noun, adjectival or adverbial forms of verb-root words, such as announcement (announce), intention (intend), operation (operate), operable (operate), and the like. With this database, every form of a word having a verb root can be identified and associated with the main root, for example, the infinitive form (present tense singular) of the verb. The verb-root words included in the dictionary are readily assembled from the passages in a library of passages, or from common lists of verbs, building up the list of verb roots with additional passages until substantially all verb-root words have been identified. The size of the verb dictionary for technical abstracts will typically be between 500-1,500 words, depending on the verb frequency that is selected for inclusion in the dictionary. Once assembled, the verb dictionary may be culled to remove generic verb words, so that words in a passage are classified either as generic or verb-root, but not both.

If a verb-root word is found, the word is converted to its verb root, so that all words related to the same verb-root word become equivalent for search purposes. Once this is done, the program generates at 92 a list of all non-generic words, including words that have been converted to their verb root.

The parsing and word classification operations above produce distilled sentences or word strings, as at 94, corresponding to text sentences from which generic words have been removed. The distilled sentences may include parsing codes that indicate how the distilled sentences will be further parsed into smaller word strings, based on preposition or other generic-word clues used in the original operation, as described in the above co-owned PCT patent application. The words in the distilled sentences or word strings are assigned word-position identifiers (WPIDs) that indicate the word position of each non-generic word in the processed paragraph. As noted above, the WPIDs may be assigned a single number representing the unique word position of the word in the processed paragraph passage, or may be assigned a pair of WPIDs, one representing a sentence identifier, and the second, a word position identifier of the word in that sentence.

In one embodiment, the word strings may be used to generate word groups, typically pairs of proximately arranged words. This may be done, for example, by constructing every permutation of two words contained in each string. One suitable approach that limits the total number of pairs generated is a moving window algorithm, applied separately to each word string, and indicated at 96 in the figure. The overall rules governing the algorithm, for a moving “three-word” window, are detailed in the above co-owned PCT patent application. The word pairs, if generated, are added to the processed passage data.

D. Generating Word-Records Databases

As noted above, the program uses word data from the processed passages in the template-documents database to generate a word-records database of file 42. This file is essentially a dictionary of non-generic words, where each word has associated with it, each TID containing that word, and for each TID, the CID for that passage and all WPIDs associated with the given word in that passage, e.g., paragraph. In forming the word-records file, and with reference to FIG. 5, the program creates an empty ordered list 42, and initializes the TID to 1, representing the first passage, e.g., paragraph in the first template document. The program reads (box 102) the word list and associated TID, CID, and WPIDs identifiers for that passage from database 40. The passage word list is initialized to w=1 at 104, and the program selects this word w at 106.

During the operation of the program, a file of word records 42 begin to fill with word records, as each new passage, e.g., paragraph is processed. This is done, for each selected word w in a paragraph, by accessing the word records database, and asking: is the word already in the database (box 108). If it is, the word record identifiers for word w in the paragraph are added to the existing word record, at 112. If not, the program creates a new word record with identifiers from the paragraph at 110. In an exemplary embodiment, every verb-root word in a template-document paragraph is converted to its verb root; that is, all verb-root variants of a verb root word are converted to a common verb root. This process is repeated until all words in the selected paragraph have been processed, through to the logic of 114, 116, then repeated for each paragraph in the database the template documents, through the logic of 118, 120.

When all passages, e.g., paragraphs in the template documents database have been so processed, the file contains a separate word record for each non-generic word found in at least one of the passages, where each word record includes a list of all TIDs, and, for each TID, the WDID, CID and preferably the WPIDs associated with that word in that passage. A word record in the database may further include other information that may be used in generating a search vector, such as selectivity values and inverse document frequencies, as described in the above co-owned patent applications. In the latter case, the system may include one or more separate word-records databases containing words from two or more different libraries of documents, such as large patent documents representing different technical fields, as detailed in the above co-owned PCT patent applications.

E. System Operation

This section considers the operation of the system in finding and displaying template passages to a user, for incorporation into a new target document. The input for the system is one of a plurality of passage summaries that the user prepares to describe the nature or content of a template paragraph that is desired. These summaries are typical one sentence or sentence-fragment descriptions of a passage of interest, or a list of word or word groups that are descriptive of the passage of interest. As examples, a user preparing a patent application concerned with the liposomes for treating cancer, the user might prepare these passage summaries:
Background—various methods currently used in treating cancer.
Background—various therapeutic uses of liposomes in human therapy, including cancer.
Background—problems or limitations associated with therapeutic uses of liposomes, such as rapid clearance by the RES or instability on storage.
Detailed Description—lipids commonly used in preparing therapeutic liposomes;
Detailed Description—different types of liposomes, such as MLV and SUVs,
Detailed Description—methods of preparing liposomes from lipid mixtures.
Detailed Description—methods of processing liposomes to produce desired uniform liposome sizes.
Detailed Description—methods of administering liposomes by intravenous injection.
Examples—an example describing the preparation of MLVs from a lipid mixture.
Examples—an example describing the effect of liposome administration on change in tumor size.
Claims—a claim covering a method of using liposomes to treat cancer.

The passage summaries may be prepared in advance, and stored in a document 128, such as a WORD document, in which case the user may simply paste a selected summary into the target input box in the user interface (see Section F). Alternatively, the user may write the summary directly into the target box ad hoc. In any event, for purposes of describing the operation of the system, it is assumed that the user will select one of a plurality of paragraph summaries S, where S is initially set to 1 at 126, and selected at 124.

From the passage summary, the program generates a search vector at 130. The search vector is composed of word and optionally word-pair terms, and for each term, a coefficient that indicates the weight that term is to be given, relative to other terms in the vector. In one embodiment, the vector terms are simply all of the non-generic words contained in the paragraph summary, with each word being assigned a coefficient value of 1. In this embodiment, the program simply reads the paragraph summary, extracts non-generic words (see above), converts verb words to verb-root words, and assigns each term a coefficient of 1.

If a more refined search is desired, the program may operate to extract both non-generic words and proximately formed word pairs in constructing the search vector, and assign to these terms either the same coefficient, e.g., 1, or a coefficient related to the term's selectivity value and/or IDF (in the case of word terms), as described in the above co-owned PCT patent application. Where term selectivity values are used in constructing the search vector, the system will include a word-records database 38 composed of words from two different libraries of passages.

Although not shown here, the vector may be modified to include synonyms for one or more “base” words in the vector. These synonyms may be drawn, for example, from a dictionary of verb and verb-root synonyms such as discussed above. Here the vector coefficients are unchanged, but one or more of the base word terms may contain multiple words, again as described in the above co-owned PCT patent application.

The search function in the system, shown at 130 in FIG. 6, operates to find the template-database passages (e.g., paragraphs) having the greatest term overlap with the target search vector terms, as indicated at 132. The passages, e.g., paragraphs searched may be confined to a particular category, or the entire database of paragraphs may be searched. In the former case, the user indicates the particular category of interest, and only those passages identified by the associated CID are considered.

Briefly, an empty ordered list of TIDs, not shown, stores the accumulating match-score values for each WDID-TID associated with the vector terms. The program initializes the vector term at 1 and retrieves term dt and all of the TIDs/WDISs (specifying both document ID and paragraph ID within a given document) associated with that term from the word-records database 42. This database, as noted above, corresponds to a particular set of template documents, and may be different for each of different target topics. If the user further specifies a document section for the search, only those TIDs having the associated CID are considered.

With each TID/WDID that is considered, the program asks: Is this TID/WDID already present in list of TID/WDIDs? If it is not, the TID/WDID and the term coefficient is added to the list, creating the first coefficient in the summed coefficients for that TID. The program may also orders the TIDs in the list numerically, to facilitate searching for TIDs in the list. If the TID is already present in the list, the term coefficient is added to the summed coefficients for that term. This process is repeated until all of the TIDs for a given term have been considered and added to the list.

Each term in the search vector is processed in this way until all vector terms have been considered. The list now consists of an ordered list of TID/WDIDs, each with an accumulated match score representing the sum of coefficients of terms contained in that TID/WDID. These TID/WDIDs are then ranked according to a standard ordering algorithm, to yield an output of the top N match score, e.g., the 5-10 highest-ranked matched score, and may be identified by TID/WDID. Details of the term-matching operation for finding highest-ranked passages are given in the above co-owned PCT patent application.

Once the initial search is completed, the results are displayed to the user at 134, for example, as a group of paragraphs that the user can scroll through to view each of the template paragraphs. The displayed paragraphs are preprocessed passages retrieved from the template documents database 40, according to WDID and TID. The user may accept the displayed paragraphs, at 136, as containing at least one which is suitable for use in the target document. Alternatively, the user may refine the search, at 135, to modify the search coefficients to either emphasize or de-emphasize certain vector terms. In the user interface presented in Section F below, this is done by displaying to the user the occurrence of each non-generic word in the search vector in the top-ranked paragraphs, and also providing for each term, user selections for modifying the relative weights (coefficient value) assigned to that word. In the embodiment shown the user can either discard the word from the search, by unclicking the word box, retain the same word value (default) enhance the word value by 5 (emphasize) or enhance the word value by 100 (require). The search is then repeated with the new search-vector coefficients, and the new results displayed to the user. Alternatively, the user can modify the paragraph summary in the passage box, and start the search anew.

When the user selects a top-ranked template paragraph, at 137, the user interface also allows the user to view adjacent paragraphs that precede or follow the selected paragraph in that template document, as indicated at 144. Using this feature, the user may select a number of related consecutive paragraphs, e.g., an entire passage, for importation into the target document. This feature also gives the user access to short document paragraphs that were not processed, but are stored as processed passage in the template documents database. Assuming one or more suitable template paragraphs are found, these are copied from the user interface for pasting into the target document. Alternatively, the system may be designed for automated transfer of the selected paragraph(s) into a word-processing document.

This search and selection protocol is carried out for all target passage summaries (TSD) through the logic of 150, 152, until each of the passage summaries has been searched. If no suitable template paragraph is found, for example, because the target description pertains to new subject matter, the user simply proceeds to the next target passage summary, until all template paragraphs of interest have been found. The user terminates the program, at 154, or has the option of adding additional template documents to the library, to try to include additional template paragraphs of potential interest.

F. User Interfaces

This section describes two user interfaces that are employed in the system of the invention, and is intended to provide the reader with a better understanding of the type of user inputs and machine outputs in the system.

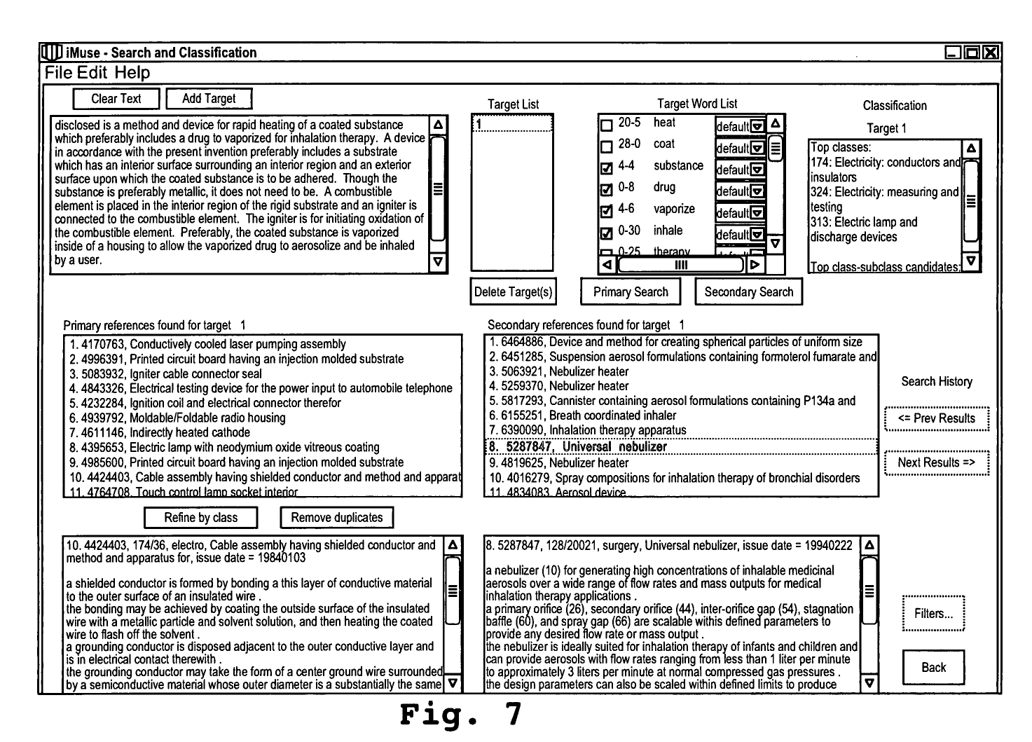

FIG. 7 shows a graphical interface in the system of the invention for use in passage searching a database of template passages, e.g., abstracts, to identify primary and secondary groups of template documents for constructing a desired template library. The target passage in this case is a description of the target topic. For example, where the system is used in preparing a patent application, the target passage may be the abstract or claim of the application to be written. This passage is entered in the passage box at the upper left. By clicking on “Add Target,” the user enters this target in the system, identified as target 1 in the Target List. The search is initiated by clicking on “Primary Search.” Here the system processes the target passages, identifies the descriptive words and word pairs in the passage, constructs a search vector composed of these terms, and searches a large database, in this example, a database of about 1 million U.S. patent abstracts in various technical fields, 1976-present.

The program operates, as described in the above co-owned patent application, to find the top-matched primary and secondary references, and these are displayed, by number and title, in the two middle passage boxes in the interface. By highlighting one of these passage displays, the passage record, including patent number, patent classification, full title and full abstract are given in the corresponding passage boxes at the bottom of the interface.

To refine the primary passages by class, the user would highlight a displayed patent having that class, and click on Refine by class. The program would then output, as the top primary hits, only those top ranked passages that also have the selected class.

To refine either the primary or secondary searches by word emphasis, the user would scroll down the words in the Target Word List until a desired word is found. The user then has the option, by clicking on the default box, to modify the word to emphasize, require, or ignore that word, and in addition, can specify at the left whether the word should be included in the primary search vector (P) or the secondary search vector (S). Once these modifications are made, the user selects either Primary search which then repeats the entire search with the modified word values, or Secondary search, in which case the program executes a new secondary search only, employing the modified search values. This interface and its underlying relationships to the search program are detailed in the above co-owned PCT patent application.

FIG. 8 shows a graphical interface in the system for finding and displaying passages of interest in document construction. The database box at the upper left indicates those template-document databases that have been entered into the system, according to the method described above. In the illustration, the database shown is called “appetite” and includes a plurality of patents, some of the U.S. patent numbers of which are shown. For this particular database, the defined categories or sections are claims, definitions, background, detailed description and examples, as shown at the upper right in the interface. Selecting a non-patent database would change the “sections” display to another group of categories, as defined by the user when the database is created. The database selected is indicated in the box called “selected database.”

To input a summary description, the user inputs a group of words, sentence fragment, whole sentence, or list or words or word pairs into the large passage box at the upper left in the interface. As indicated above, this summary describes or encapsulates the content of the passage the user which to locate in the system. The input may be from pasted into the box from a pre-existing passage, or typed directly into the box. With the passage summary entered, the user specifies a Section of category, at the upper right, and clicks on Create Word List, to view the non-generic words in the summary and the number of times the words are found in the top ten passages identified from the search of passages.

The Score box at the lower left in the interface indicates the number of words in the Target Word list that are found in each of the top tewn passage hits for the search. By highlighting any of these numbers, the corresponding document passage is displayed in the lower central text box. The target words contained in that passage are indicated in the lower right box.

At this point, the user my view each of the top-ten matched passages, and if a desired passage is found, copy the text from that passage into the target document being processed (using ordinary copy and paste operations). In addition, if the user finds a passage, e.g., paragraph of interest, he/she may view adjacent passages in the same document by clicking on previous (preceding paragraph) or next paragraph. These additional paragraphs may similarly be copied and pasted into the document under preparation.

If the user wishes to refine or enhance the search, in an attempt to find a more pertinent passage, and particularly, to find a passage with one or more desired word terms, the user may modify the weight of any or all of the word terms, by going to the Target Word List and unclicking the box for that word to discard the word from the search, or clicking on one of “default,” emphasize,” or “require,” to set the associated word's search-vector coefficient to 1 (default), 5 (emphasize), or 100 (require). When the Search button is clicked, the program initiates a new search of the document passages, using the search vector with the user-specified coefficients. The results are displayed to the user as described.

While the invention has been described with respect to particular embodiments and applications, it will be appreciated that various changes and modification may be made without departing from the spirit of the invention.

1. A computer-assisted method for constructing a target document composed of a series of descriptive passages that describe a topic, comprising
(a) representing each of a plurality of descriptive passages that are to be included in the target document in the form of a summary description of the content of that passage,
(b) for each summary description represented according to step (a), accessing a database of word records containing (i) non-generic words contained in a set of descriptive passages taken from a plurality of template documents that represent topics similar to those of the target document, and (ii) for each word in said database, passage identifiers associated with that word in the set of descriptive passages, to identify those words contained in the summary description that are contained in said database,
(c) using the passage identifiers associated with the words identified in step
(b) to identify those descriptive passages having the highest word overlap with the summary description,
(d) accessing a database of said descriptive passages identified by passage identifiers to retrieve those passages identified in (c)
(e) displaying to the user, one or more of the descriptive passages retrieved in step (d),
(f) if the descriptive passages displayed in (e) contain a passage suitable for insertion into the target document, selecting that passage to replace the summary description of the content of that passage in the target document, and
(g) repeating steps (c)-(f) for each of the summary descriptions in (a).

2. The method of claim 1, wherein
step (c) includes constructing a search vector composed of non-generic word terms present in said description,
step (c) further includes displaying to the user, the terms in the search vector that are present in the identified descriptive passages, and, optionally the number of passages containing that term, allowing the user to adjust the search vector to eliminate, emphasize or de-emphasize selected terms, and
step (g) further includes repeating steps (c)-(f) until a suitable descriptive passage is found or the user concludes that no suitable descriptive passage is present in the database of descriptive passages.

3. The method of claim 2, wherein each non-generic word in the summary description is assigned the same coefficient.

4. The method of claim 2, wherein each non-generic word in the summary description is assigned a coefficient related to the ratio of (i) number occurrence of a term in a library of passages related to one field, to (ii) the number occurrence of the same terms in one or more other fields.

5. The method of claim 1, wherein the summary description of the content of a passage is represented as a description in natural-language passage, step (b) further includes classifying words in the summary description as either (i) generic, (ii) verb-root, or (iii) remaining words that are neither (i) nor (ii), discarding generic words, and converting verb-root words to a common verb root, and verb-root words in said database of word records are expressed in verb-root form.

6. The method of claim 1, wherein the words in said word-records database includes word-position identifiers that identify the word position(s) of that word in each descriptive passage containing that word, step (b) further includes identifying word-pair terms from proximately arranged words in said summary description, and step (c) includes using document, passage, and word-position identifiers in said word-record database associated with the word-pair terms identified in step (b) to identify those descriptive passages having the highest word and word-pair overlap with the summary description.

7. The method of claim 1, wherein the words in said word-records database include category identifiers that identify a category of a template document from which the associated descriptive passage is found, step (a) includes specifying a category identifier for each summary description of the content of a given passage, and step (c) includes using passage and category identifiers in said file associated with the words identified in step (b) to identify those descriptive passages having the specified category and the highest word overlap with the summary description.

8. The method of claim 7, for use in preparing a patent specification, wherein the template documents are patents or patent applications and the categories include two or more from the group consisting of background, definitions, description, examples, and claims.

9. The method of claim 7, for use in preparing a legal agreement, wherein the template documents are already-prepared agreements, and the categories include two or more from the group consisting of recitals, definitions, grant, rights, obligations, term, termination, and miscellaneous.

10. The method of claim 7, for use in preparing a scientific report, wherein the template documents are existing scientific reports, and the categories include at least two from the group consisting of introduction, methods, results, and discussion.

11. The method of claim 1, wherein said descriptive passages in said documents are document paragraphs having a word length greater than a selected length.

12. The method of claim 11, wherein said database of descriptive passages includes all of the paragraphs of the template documents, and step (e) includes displaying to the user, on command, document paragraphs that precede and follow a selected displayed paragraph.

13. An automated system for constructing a target document which represents a selected target topic and is composed of a series of descriptive passages related to that topic, comprising
(1) a computer,
(2) accessible by said computer, (a) a database of descriptive passages constructed from a plurality of template documents which represent topics similar to those of the target document, and (b) a word-records database composed of (i) non-generic words contained in said descriptive passages, and (ii) for each word in said word-records database, passage identifiers associated with that word in the set of descriptive passages, and
(3) a computer readable code which is operable, under the control of said computer, to perform the steps of claim 1.

14. The system of claim 13, wherein the words in said word-records database further include category identifiers that identify a category of a template document from which the associated descriptive passage is found.

15. Computer readable code for use with an electronic computer, a database of descriptive passages taken from a plurality of template documents which represent topics similar to those of the target document, and a word-records database composed of (i) non-generic words contained in said descriptive passages, and (ii) for each word in said word-records database, passage identifiers associated with that word in the set of descriptive passages, for use in for constructing a target document which represents a selected topic and is composed of a series of descriptive passages related to that topic, wherein said code is operable, under the control of said computer, to perform the steps of claim 1.
